(19) United States
(12) Patent Application Publication
(10) Pub. No.: US 2012/0192598 A1
(43) Pub. Date: Aug. 2, 2012

(54) LASED LEATHER ODOR REDUCTION

(76) Inventor: William Frederick DEGROOT, Batavia, IL (US)

(21) Appl. No.: 13/361,160

(22) Filed: Jan. 30, 2012

Related U.S. Application Data
(60) Provisional application No. 61/437,173, filed on Jan. 28, 2011.

(51) Int. Cl. C14B 1/46; B23K 26/36; F27D 7/00; C14B 99/00

(52) U.S. Cl. 69/21; 432/19; 219/121.69; 432/201

(57) ABSTRACT

A method for reducing a burned odor characteristic of lased leather is provided. Lased leather having a burned odor characteristic is heated, and the heated lased leather is subjected to a forced gas flow to reduce the burned odor characteristic of the lased leather. A system and a method for producing laser-marked leather with reduced burned odor characteristic are also provided. The system features laser marking equipment for producing laser-marked leather having a burned odor characteristic, and treatment equipment for heating and subjecting the laser-marked leather to forced gas flow to reduce the burned odor characteristic of the laser-marked leather.

### CLAIM OF PRIORITY AND CROSS-REFERENCE TO RELATED APPLICATION

This application claims the benefit of priority of provisional application No. 61/437,173 filed Jan. 28, 2011 entitled “Lased Leather Odor Reduction,” the complete disclosure of which is incorporated herein by reference.

### FIELD OF THE INVENTION

The present invention relates to odor reduction in the context of laser marking leather.

### BACKGROUND OF THE INVENTION

Laser marking (also known as laser etching and laser scribing) is emerging as a new method for marking leather goods and articles. In particular, laser marking has the ability to create unique designs not feasible or possible with alternative technologies such as embossing. Because the laser marking process is primarily a digital process, unique and finely detailed designs and patterns can be created from graphic images obtained through different sources. Such graphic images can be drawn from scratch in programs such as Adobe Illustrator, downloaded from the Internet, or scanned from printed copies. The designs and patterns can include graphic images, logos, trademarks, alphanumeric codes, words, repeating patterns of graphics, random patterns of graphics, perforations, fake perforations (where the laser does not fully penetrate the lased object but gives the appearance of a perforation), and any combination of these and other designs.

As such, new and unique aesthetics can be created for automobile interiors, furniture, apparel, etc. using the laser marking process. The process can be performed very quickly and has the added advantage of permitting production of a single custom design or mass production of hundreds, thousands, or millions of units of the same design quickly and efficiently. The number of different designs and patterns that can be created is essentially limited only by the imagination of the designer.

However, laser marking processes have a drawback when applied to leather. The laser burns leather to make the intended mark. In doing so, unwanted by-products are generated, as demonstrated by the Fourier transform infrared (FTIR) spectroscopy bands of FIGS. 3 and 4. The FTIR spectroscopy band of a laser-marked leather (FIG. 3) is noticeably different than the FTIR spectroscopy band of leather that has not been laser marked (FIG. 4). The by-products are believed to be degradation products of proteins in the leather, and are further believed to be responsible for the sharp and offensive odor of laser-marked leather.

Conventional methods for reducing or masking the odor of lased leather, such as chemicals, specifically perfumes, and UV exposure have achieved limited to no success. Further, perfumes often are undesirable because in addition to masking the burned odor, the perfumes may also mask the smell of the natural leather, which is an attribute desired by many consumers.

### SUMMARY OF THE INVENTION

A first aspect of the invention provides a method for reducing a burned odor characteristic of laser-marked leather. Laser-marked leather having a burned odor characteristic is heated, and the heated laser-marked leather is subjected to a forced gas flow to reduce the burned odor characteristic of the laser-marked leather.

A second aspect of the invention relates to a method for producing laser-marked leather with a reduced burned-odor characteristic. The method involves laser making leather to provide laser-marked leather having a burned odor characteristic, heating the laser-marked leather, and subjecting the heated laser-marked leather to a forced gas flow to reduce the burned odor characteristic of the laser-marked leather.

A third aspect of the invention relates to a system for producing laser-marked leather with a reduced burned-odor characteristic. The system of this third aspect features laser marking equipment for producing laser-marked leather having a burned odor characteristic, and treatment equipment for heating and subjecting the laser-marked leather to forced gas flow to reduce the burned odor characteristic of the laser-marked leather.

A fourth aspect of the invention relates to a laser-marked leather with a reduced burned-odor characteristic treated in accordance with a method and/or a system of the present invention.

Other aspects of the invention, including apparatus, systems, methods, kits, equipment, and the like which constitute part of the invention, will become more apparent upon reading the following detailed description of the exemplary embodiments and viewing the drawings.

### BRIEF DESCRIPTION OF THE DRAWING(S)

The accompanying drawings are incorporated in and constitute a part of the specification. The drawings, together with the general description given above and the detailed description of the exemplary embodiments and methods given below, serve to explain the principles of the invention. In such drawings:

FIG. 1 is a flow diagram according to an exemplary embodiment of the invention;

FIG. 2 is a system according to an exemplary embodiment of the invention;

FIG. 3 is a Fourier transform infrared (FTIR) spectroscopy band for laser-marked, untreated leather (x axis=wave number cm⁻¹/y axis=absorbance); and

FIG. 4 is a Fourier transform infrared (FTIR) spectroscopy band for a non-lased, untreated leather control sample (x axis=wave number cm⁻¹/y axis=absorbance).

### DETAILED DESCRIPTION OF EXEMPLARY EMBODIMENTS AND EXEMPLARY METHODS

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative equipment and methods, and illustrative examples shown and described in connection with the exemplary embodiments and methods.

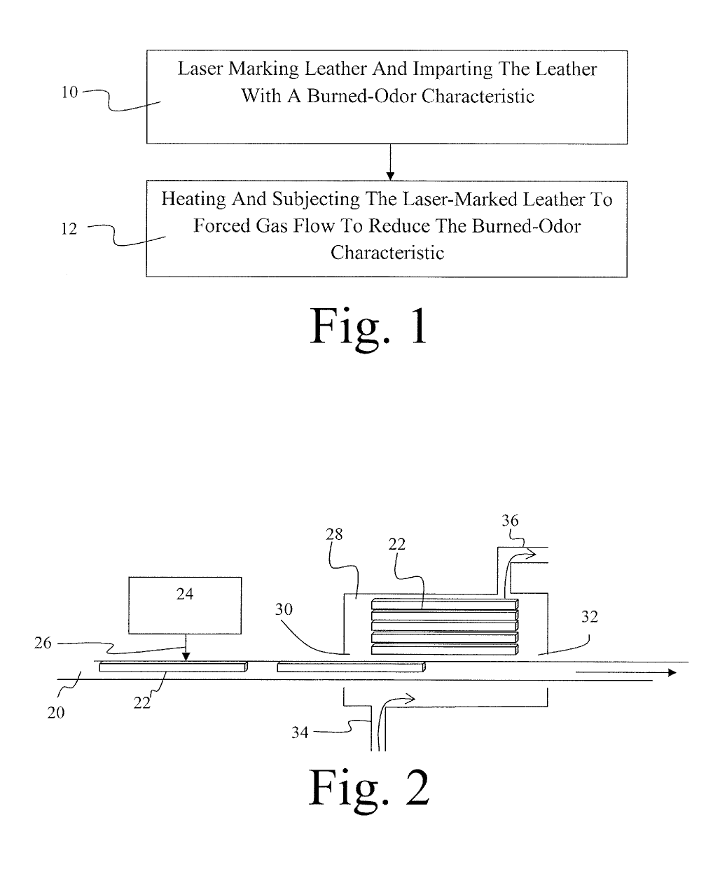

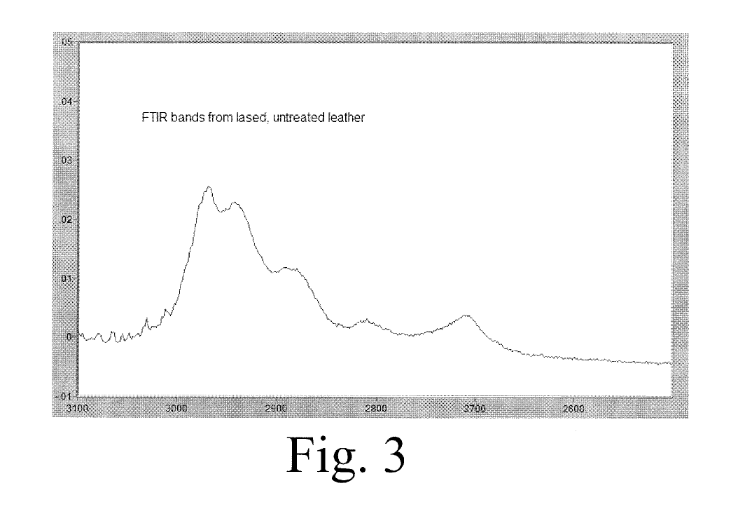

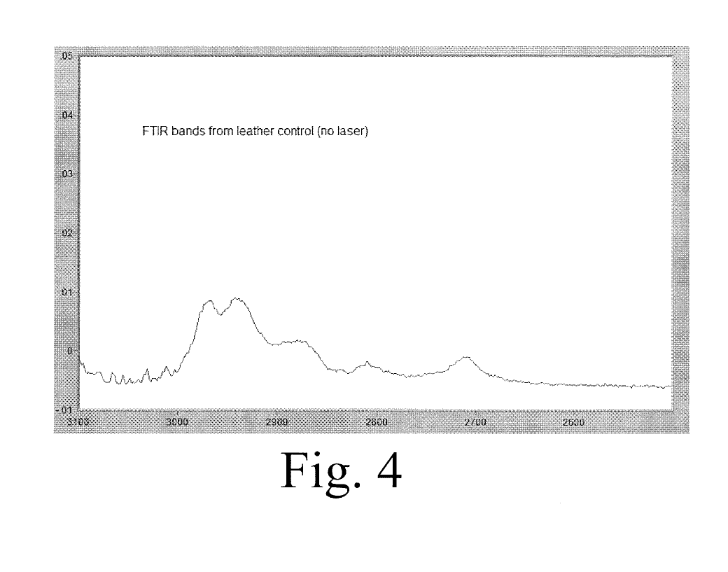

In the method illustrated in FIG. 1, laser-marked leather with a burned-odor characteristic is provided at 10. Laser-marking may be performed on one or more surfaces of the leather, and may involving marking, etching, scribing with a laser one or more graphic designs on, in, or through the leather surface and/or the leather. In the course of laser marking (also referred to and in the art as laser etching, laser scribing, or lasing), a laser beam causes a change to the leather surface that is visually perceptible to the unaided human eye. This “change” may involve the removal, ablation, etching, or discoloration, for example. The visually perceptible change may be in the form of a shallow recess of a depth that extends partly through the leather, without cutting entirely through the leather or penetrating partially. The recess may be configured as a channel, groove or trench, cavity, or other depression. Alternately, the laser marking may be limited to the surface only, or a color change to a dye contained in the leather.

Alternatively, or in addition to the surface marking described above, laser marking may involve perforating the leather with the laser. Laser perforating an article creates one or more small holes, slots, or other pass-throughs in an article. Each perforation may extend completely through the leather. For example, the leather upholstery of seats, such as vehicle (e.g., car, SUV, truck, etc.) seats may be perforated with small holes to improve appearance and/or water-vapor permeability properties of the seats.

As shown in the flowchart of FIG. 1, the laser-marked leather is subjected to heating and forced gas flow treatment at 12 to reduce or eliminate the burned-odor characteristic from the laser-marked leather. Heat treatment in exemplary embodiments involves heating the laser-marked leather to a temperature sufficient to convert the degradation byproducts produced during laser marking into volatiles that may be removed by the forced gas flow stream. However, the temperature should not be so high as to damage the leather.

Generally, temperatures in the range of 100° C.-120° C. have been found acceptable. It is within the purview of a skilled artisan to determine suitability of temperatures outside of this range. The gas used for treating the laser-marked leather may be, for example, air or an inert gas (e.g., nitrogen, argon). The forced gas flow rate and residence time for which the leather is subjected to the forced gas flow should be sufficient so that the volatiles generated by heating of the laser-marked leather are entrained/carried off with the forced gas flow. The application of heat and forced gas may be carried out, for example, for at least approximately 10 minutes, more suitable approximately 30 minutes, and still more suitably at least approximately 60 minutes on the leather article. Temperature, forced flow rate, and residence time are interdependent on one another. Generally, lower forced gas flow rates and residence times may be employed at higher temperatures. As the heating temperature is decreased, the forced gas flow rate and/or residence time may be increased.

Multiple leather articles may be subjected to the method in batch processing or in quick succession, such as on a conveyor belt of a production line. Alternatively, individualized leather articles may be treated one at a time. A computer controller used to control the marking or lasing process may facilitate the transition from a one-off product to a series of identically-marked products.

Methods of laser-marking are set forth in U.S. Pat. No. 5,990,444 issued Nov. 23, 1999 entitled “Laser Method and System for Scribing Graphics,” and PCT Application No. PCT/US2008/007316 filed Jun. 12, 2008 entitled “High Speed and High Power Laser Etching of Building Products” and PCT/US2009/02546 filed Apr. 24, 2009, entitled “Combination Extrusion and Laser-Marking System, and Related Method.” The teachings of the U.S. patent and the International patent applications with respect to lasing may be adapted by those skilled in the art to laser mark leather.

Leather goods that may be treated in accordance with these exemplary embodiments include, for example, automobile interior products such as seats, headrests, and door panels; clothing items such as jackets, belts, shoes, purses, wallets, and pocketbooks; business-related items such as briefcases and personal organizer holders; household and residential and commercial furniture such as sofas and chairs; and other items. It should be understood that the leather article may contain components or portions made of material(s) other than leather, for example, plastic or metal components.

Graphic designs referred to herein may encompass decorative and artistic designs. The graphic design may include repeating patterns such as diamond, hounds tooth or chevron patterns, or non-repeating graphic designs, such as floral designs. The graphics may be simple geometric shapes or highly complex shapes and/or alphanumeric information, such as logos, words, names, initials and/or numbers (e.g., in the case of vehicle upholstery the graphic may feature the vehicle model and/or make). As discussed in greater detail below, exemplary embodiments of the invention permit the marking of advanced, highly aesthetic designs to allow the manufacture of premium products in an economical manner for high output industrial production.

FIG. 2 shows a system for reducing or eliminating the burned-odor characteristic of laser-marked leather in accordance with an exemplary embodiment. The system includes a continuous conveyor 20 (traveling left to right, as indicated by the arrow in FIG. 2) carrying a plurality of leather articles 22. Laser equipment 24 applies a laser beam 26 to a surface of the leather articles 22 to mark the surface at a first station. The marked leather articles 22 are transferred on the conveyor 20 into an inlet 30 of a second station including a treatment apparatus 28. The treatment apparatus 28 may be, for example, a forced-air furnace. Forced gas enters the treatment apparatus 28 through inflow port 34 and exits with the vaporized volatiles through outflow port 36. The forced gas optionally may be preheated. The laser-marked leather article 22, having been partially or completely deodorized by the forced gas, exits the treatment apparatus 28 on conveyor 20 through outlet 32.

It should be understood that modifications and variations may be made to the system illustrated in FIG. 2. For example, the system may contain multiple lasers 24 and/or multiple treatment apparatus 28. The laser equipment 24 and treatment apparatus 28 can be consolidated into an integral apparatus. Alternatively, heating and forced gas flow may take place in separate apparatus or separate stations. Additional stations, such as a separate heating station before (upstream of) the treatment apparatus 28 may be added.

As shown in FIG. 2, the system is carried out in batch mode, with the leather articles 22 loaded into and stacked in the treatment apparatus 28 for receiving the forced gas flow. Batch operations may be desirable, especially where the residence time in the treatment apparatus 28 is long relative to the time required to mark the leather with the laser equipment 24. For example, lasing may take only several seconds, whereas heating and forced gas treatment may take, for example, approximately 10 minutes or more, and possibly an hour or longer. Alternatively, it is possible to carry out the system in continuous mode, if desired. These are just a few select examples of modifications and variation that may be implemented.

Although the exemplary methods and systems described above do not use perfumes and other chemicals (e.g., Zorbax, TiO₂), the use of such perfumes and chemicals is not prohibited.

### EXAMPLES

### Example 1

A lased sample was heated in an enclosed tube with a nitrogen purge gas to drive volatile products into a heated FTIR gas cell positioned in a beam of an FTIR spectrometer. Twenty FTIR spectra (one taken every two minutes) were recorded as the heating apparatus temperature was ramped from room temperature to 100° C. during the first 10 scans (approximately 20 minutes), then gradually increased to approximately 110° C. over the following 10 scans (another approximately 20 minutes). Odor components were quantified as the intensity of the infrared absorption bands from the lased leather sample and a control leather sample. After heat treatment and FTIR analysis, the samples were smelled for a malodorous burned scent, and it was noted that the burned odor characteristic was significantly reduced if not eliminated.

### Example 2

The procedures of Example 1 were repeated, except that heating conditions were changed to 120° C. and applied overnight. A beneficial effect on odor reduction was achieved, and the burned-odor characteristic was essentially eliminated.

### Example 3

The procedures of Example 1 were repeated, except that heating conditions were changed to 100° C. for 4 hours. A beneficial effect on odor reduction was achieved, and the burned-odor characteristic was essentially eliminated.

### Example 4

The procedures of Example 1 were repeated, except that heating conditions were changed to 100° C. for 0.5 hr. Although the odor reduction was not as great as in Examples 2 or 3, significant burned-leather odor reduction was still noted.

The foregoing detailed description of the certain exemplary embodiments of the invention has been provided for the purpose of explaining the principles of the invention and its practical application, thereby enabling others skilled in the art to understand the invention for various embodiments and with various modifications as are suited to the particular use contemplated. This description is not intended to be exhaustive or to limit the invention to the precise embodiments disclosed. Although only a few embodiments have been disclosed in detail above, other embodiments are possible and the inventors intend these to be encompassed within this specification and the scope of the appended claims. The specification describes specific examples to accomplish a more general goal that may be accomplished in another way. Modifications and equivalents will be apparent to practitioners skilled in this art and are encompassed within the spirit and scope of the appended claims and their appropriate equivalents. This disclosure is intended to be exemplary, and the claims are intended to cover any modification or alternative which might be predictable to a person having ordinary skill in the art.

Only those claims which use the words “means for” are to be interpreted under 35 USC 112, sixth paragraph. Moreover, no limitations from the specification are to be read into any claims, unless those limitations are expressly included in the claims.

What is claimed is:

1. A method for reducing a burned odor characteristic of laser-marked leather, comprising heating laser-marked leather having a burned odor characteristic and subjecting the heated laser-marked leather to a forced gas flow to reduce the burned odor characteristic.

2. The method of claim 1, wherein said heating and the forced gas flow are carried out for at least approximately 10 minutes.

3. The method of claim 1, wherein said heating and the forced gas flow are carried out for at least approximately 30 minutes.

4. The method of claim 1, wherein said heating and the forced gas flow are carried out for at least approximately 60 minutes.

5. The method of claim 1, wherein the heating is carried out at a temperature in a range of approximately 100° C. to approximately 120° C.

6. The method of claim 1, wherein said heating is carried out at a temperature sufficiently high to vaporize volatiles from the laser-marked leather but not so high as to damage the laser-marked leather.

7. The method of claim 1, wherein the forced gas flow mostly comprises air.

8. The method of claim 1, wherein the forced gas flow mostly comprises an inert gas.

9. The method of claim 1, wherein a perfume is not applied to the laser-marked leather.

10. A method for producing laser-marked leather with reduced burned odor characteristic, comprising:
laser marking leather to provide laser-marked leather having a burned odor characteristic;
heating the laser-marked leather; and
subjecting the heated laser-marked leather to a forced gas flow to reduce the burned odor characteristic of the laser-marked leather.

11. The method of claim 10, wherein said heating and the forced gas flow are carried out for at least approximately 10 minutes.

12. The method of claim 10, wherein said heating and the forced gas flow are carried out for at least approximately 30 minutes.

13. The method of claim 10, wherein said heating and the forced gas flow are carried out for at least approximately 60 minutes.

14. The method of claim 10, wherein the heating is carried out at a temperature in a range of approximately 100° C. to approximately 120° C.

15. The method of claim 10, wherein said heating is carried out at a temperature sufficiently high to vaporize volatiles from the laser-marked leather but not so high as to damage the laser-marked leather.

16. The method of claim 10, wherein the forced gas flow mostly comprises air.

17. The method of claim 10, wherein the forced gas flow mostly comprises an inert gas.

18. The method of claim 10, wherein a perfume is not applied to the laser-marked leather.

19. A system for producing laser-marked leather with reduced burned odor characteristic, comprising laser marking equipment for producing laser-marked leather having a burned odor characteristic, and treatment equipment for heating and subjecting the laser-marked leather to forced gas flow to reduce the burned odor characteristic of the laser-marked leather.

20. The system of claim 19, wherein the treatment equipment comprises a forced-air furnace.
